(19) United States
(12) Patent Application Publication
(10) Pub. No.: US 2010/0190027 A1
(43) Pub. Date: Jul. 29, 2010

(54) EXTRUDED PRODUCTS IN ALUMINIUM ALLOY Al-Mn WITH IMPROVED MECHANICAL STRENGTH

(75) Inventors: Bruce Morere, Dijon (FR); Annabelle Bigot, Renage (FR); Jerome Pignatel, La Chapelle sur Erde (FR)

Correspondence Address: DENNISON, SCHULTZ & MACDONALD, 1727 KING STREET, SUITE 105, ALEXANDRIA, VA, 22314, US

(73) Assignee: ALCAN RHENALU, Courbevoie (FR)

(21) Appl. No.: 12/670,538

(22) PCT Filed: Jul. 21, 2008
(86) PCT No.: PCT/FR2008/001074

§ 371 Date: Jan. 25, 2010

(30) Foreign Application Priority Data
Jul. 27, 2007 (FR) 0705510

(51) Int. Cl. F16L 9/00; C22C 21/08; C22F 1/04

(52) U.S. Cl. 428/586; 420/532; 148/550

(57) ABSTRACT

An extruded product, in particular a tube, made of alloy composed as follows (% by weight): Si<0.30, Fe:<0.30, Cu<0.05, Mn: 0.5−1.2, Mg 0.5−1.0, Zn<0.20, Cr: 0.10−0.30, Ti<0.05, Zr<0.05, Ni<0.05, others<0.05 each and<0.15 total, the remainder aluminum. The invention is further directed to a manufacturing process for tubes extruded from this composition including the steps of casting a billet, optionally homogenizing this billet, extruding a tube, drawing this tube in one or more passes, and continuously annealing at a temperature ranging between 350 and 500° C. with a rise in temperature of less than 10 seconds. The tubes according to the invention are advantageously used for air-conditioning systems for the passenger compartment of motor vehicles using CO₂ as a refrigerating gas.

### FIELD OF THE INVENTION

The invention relates to extruded products made of aluminum Al—Mn alloy (series 3000 according to the nomenclature of the Aluminum Association) with improved mechanical resistance, especially tubes designed in particular for piping or heat exchangers for automotive engineering.

### BACKGROUND OF RELATED ART

Today, three vehicles out of four sold in France have air-conditioning. In 2020, nine vehicles out of ten will be air-conditioned. Automobile air-conditioning has a considerable impact on climate change for two main reasons. The first is the extra fuel consumed. This depends greatly on the type of vehicle and how it is used, but is estimated at an average of 7% of fuel consumed. The second is related to losses of refrigerant. The fluid currently used today (HFC-R134a, CH2 FCF3) has an impact on the greenhouse effect approximately one thousand four hundred times greater than the equivalent mass of carbon dioxide (CO2) and it is usually accepted that each vehicle loses a third of the contents (approximately 900 g) of the cooling circuit each year.

Many studies are currently examining the replacement of hydrofluorocarbons (HFC) with CO2 for air-conditioning systems. Even though CO2 is a greenhouse gas, its impact is much lower than that of HFCs, which may make it possible to decrease the noxiousness of emissions related to leaks.

An air-conditioning system running on CO2 as a refrigerating gas is based on the compression and expansion of gas. A compressor compresses the CO2 at high pressure and this then moves into a gas cooler (usually called condenser, but in which condensation does not occur when the refrigerant is CO2), then into an internal heat exchanger (which allows heat exchange with the low pressure zone). The CO2, still as a gas then moves into a pressure reducer from which comes a liquid which cools the passenger compartment by passing through an evaporator. The low pressure gas then accumulates before circulating inside the internal heat exchanger and returning to the compressor for a new cycle. Extruded products made of aluminum can be used to manufacture the heat exchangers (gas cooler and evaporator) and/or to produce the piping allowing the refrigerant to circulate between the various parts of the cooling circuit.

The use of CO2 as refrigerant is made difficult because of the pressure at which it must be used. The critical temperature of CO2 is lower than that of HFC-134a and its critical pressure is higher, which means that the air-conditioning system has to run at to higher pressures and temperatures than those currently in use, whether in the high pressure part or the low pressure part of the circuit. The materials used in the air-conditioning circuit must therefore be more hard-wearing than currently used materials, while maintaining performance levels that are at least equivalent in terms of manufacture, shaping, assembly and corrosion resistance. For good refrigerating efficiency, CO2 therefore needs to be compressed with high pressures of about 100 to 200 bar. Because of this, in order for CO2 to be used as a refrigerant, the piping must withstand an operating pressure of 200 bar for high temperatures of 130-170° C., which is high compared to current conditions: about 5 bar at 60° C.

Alloys have been proposed for the production of flat tubes for heat exchangers (gas coolers and evaporators) of air-conditioning systems using CO2 as refrigerating gas. JP 2005-068557 describes an alloy composed as follows (% by weight) Mn: 0.8−2, Cu: 0.22−0.6, Ti: 0.01−0.2, Fe: 0.01−0.4, Zn≦0.2, Sn≦0.018, In≦0.02.

JP 2007-070699 describes an alloy composed as follows (% by weight) Si: 0.31−0.7, Fe: 0.3−0.6, Mn: 0.01−0.4, and as an option Ti 0.01−0.3, Zr 0.05−0.3, Cr 0.05−0.3.

These alloys do not seem to make it possible to reach some of the required performance levels in terms of hardness, in particular for tubes designed for piping. In addition, several alloys of the 3XXX series are known for the production of tubes designed for air-conditioning systems using conventional refrigerating gases.

Patent application WO 97/46726 by Reynolds Metals relates to an alloy, known as X3030, composed as follows (% by weight): Mn: 0.1−0.5, Cu<0.03, Mg<0.01, Zn: 0.06−1.0, Si: 0.05−0.12, Fe<0.50, Ti: 0.03−0.30, Cr<0.50, the rest aluminum. Adding Zn and Ti contributes to improved corrosion resistance. Cr is maintained preferably below 0.20%.

Patent application WO 99/18250 by the same company relates to an alloy designated as X3020 with better formability than X3030 by the addition of Mg (up to 1%) and

Zr (up to 0.30%). Cr is maintained preferably below 0.02%, or even 0.01%; Ti is maintained preferably above 0.12% and Zn above 0.1%.

Patent application WO 00/50656 by Norsk Hydro relates to an alloy composed as follows: Si: 0.05−0.15, Fe: 0.06−0.35, Cu<0.10, Mn: 0.01−1.0, Mg: 0.02−0.60, Cr<0.25, Zn: 0.05−0.70, Ti<0.25, Zr<0.20.

Cr is maintained preferably below 0.15% and is allowed only for reasons of recycling off-cuts of other alloys. Zn is maintained preferably above 0.1%.

Patent application WO 02/055750 by the applicant relates to an alloy with improved corrosion resistance composed as follows : 0.20−0.50, Cu<0.05, Mn: 0.5−1.2, Mg<0.05, Zn<0.50, Cr: 0.10−0.30, Ti<0.05, Zr<0.05.

The problem which the present invention answers is to manufacture a product extruded from alloy 3XXX with improved mechanical resistance, in order to be able to withstand high pressures, especially for operating temperatures ranging between 130 and 170° C., and with identical or higher performance levels in term of manufacture, shaping, assembly and corrosion resistance than those of current products.

### SUBJECT OF THE INVENTION

The subject of the invention is a extruded product, in particular a drawn tube, made of alloy composed as follows (% by weight): Si<0.30, Fe<0.30, Cu<0.05, Mn: 0.5−1.2, Mg 0.5−1.0, Zn<0.20, Cr: 0.10−0.30, Ti<0.05, Zr<0.05, Ni<0.05, others <0.05 each and <0.15 total, the rest aluminum.

Contents are preferably (% by weight): Si 0.05−0.15, Fe: 0.05−0.25, Cu<0.01, Mn: 0.9−1.1, Mg 0.6−0.9, Zn:<0.05, Cr: 0.15−0.25, Ti<0.04, Zr<0.04, Ni<0.01.

Another subject of the invention is a manufacturing process for tubes extruded from an alloy according to the invention including casting a billet, possibly homogenizing this billet, spinning a tube, drawing this tube in one or more passes, and continuous annealing at a temperature ranging between 350 and 500° C. with a rise in temperature of less than 10 s.

Still another subject of the invention is the use of a product extruded according to the to invention in the manufacture of motor vehicles.

### DESCRIPTION OF THE INVENTION

Unless otherwise stated, all indications relating to the chemical composition of alloys are expressed as a percentage by weight. The designation of alloys follows the rules of The Aluminum Association, known to experts in the field, as well as EN standard 573-1. The metallurgical states are defined in European standard EN 515. The chemical composition of standardized aluminum alloys is defined for example in EN standard 573-3. Unless otherwise specified, static mechanical characteristics, i.e. breaking strength Rₘ, yield stress R_{p0.2}, and elongation at break are determined by a tensile test according to standard EN 10002-1 and EN 754-2. The term “extruded product” includes so-called “drawn” products, i.e. products which are manufactured by spinning followed by drawing.

Unless otherwise specified, the definitions of European standard EN 12258-1 apply. The alloy of the 3XXX series according to the invention has a relatively high magnesium content and a zinc content low enough to be considered as mere impurities. In contrast to what is learnt from prior art, which recommends adding titanium and zinc to alloys of the series 3XXX to improve their corrosion resistance, the alloy according to the invention has good corrosion behavior with a zinc content and a titanium content low enough to be considered as mere impurities. So the zinc content must be lower than 0.20% by weight, preferably lower than 0.05% by weight and preferably still lower than 0.04% by weight. Similarly, the titanium content must be lower than 0.05% by weight, preferably lower than 0.04% by weight and preferably still lower than 0.03% by weight. In addition, the low zinc and titanium contents are an advantage with regard to recycling the alloy products according to the invention.

The magnesium content lies between 0.5 and 1.0% by weight and preferably between 0.6 and 0.9% by weight. Adding magnesium with a content of at least 0.5% by weight and preferably at least 0.6% by weight makes it possible to very significantly increase mechanical resistance. The magnesium content must however be limited to a maximum of 1.0% by weight and preferably to 0.9% by weight to ensure satisfactory product solderability and good performance in terms of extrusion potential.

Adding chromium at a concentration ranging between 0.10 and 0.30% by weight and preferably at a concentration ranging between 0.15 and 0.25% by weight makes it possible to improve the alloy's corrosion resistance.

Manganese is the main alloy element. It is added at a concentration ranging between 0.5 and 1.2% by weight and preferably at a concentration ranging between 0.9 and 1.1% by weight.

The iron and silicon content must be lower than 0.30% by weight. Advantageously, the iron content is at the most 0.25% by weight and the silicon content is at the most 0.15% by weight. Too high a content of these elements is a factor in reducing corrosion resistance. It is preferable, mainly for economic reasons of recycling, for silicon and iron contents to be at least 0.05% by weight.

Adding other elements may have a harmful effect on the alloy, and these must therefore have a content of less than 0.05% by weight and less than 0.15% in total. In particular, the presence of zirconium, nickel or copper may lower corrosion resistance properties, and the content of these elements must be less than 0.05% by weight. Preferably, the nickel and copper content is less than 0.01% by weight and the zirconium content is less than 0.04% by weight.

The manufacturing process for extruded products, in particular tubes, involves casting billets of the alloy indicated, possibly homogenizing the billets, reheating and spinning them to obtain a straight length of tube or a coil, and, as an option, one or more drawing passes to bring the product to the required dimensions. The tube may, if it is stretched, then advantageously be continuously annealed by running at high speed in a continuous furnace, preferably an induction furnace. The extruded product is very quick to reheat: less than 10 seconds, and preferably less than 2 seconds, and the product runs at a speed ranging between 20 and 200 m/min Furnace temperature is maintained at between 350 and 500° C. After annealing, the product may be drawn again to increase mechanical resistance (state H).

This continuous annealing gives a microstructure with fine equiaxed grains, of average grain size, measured by the intercept method, of less than 40 μm, and typically about 25 μm. The fine grain microstructure is advantageous especially with regard to the tubes' mechanical properties and corrosion resistance.

The products according to the invention have high mechanical resistance. So in the H12 state, the breaking strength at room temperature is increased by at least 40% compared to a product according to application WO 02/055750 with a comparable manganese content. Surprisingly, the advantage is even more marked for tests carried out at high temperature. So in the H12 state, the breaking strength at 170° C. is increased by almost 60% compared to a product according to application WO 02/055750 with a comparable manganese content. In particular, products extruded according to the invention have, in H12 state, a breaking strength Rm greater than 150 MPa at room temperature and greater than 140 MPa at 170° C. Moreover, products extruded according to the preferential composition of the invention have, in H12 state, a breaking strength Rm greater than 160 MPa at room temperature and greater than 150 MPa at 170° C. The relative plastic variation R_{p%}, defined by the ratio R_{p%}=(Rₘ−R_{p0,2}) R_{p0,2}, makes it possible to evaluate the potential for plastic deformation without breaking. Products according to the invention have, in H12 state, a plastic variation at room temperature slightly lower than that of products according to application WO 02/055750 but, surprisingly, an improved relative plastic variation for test temperatures higher than, or equal to, 130° C. So in H12 state, the relative plastic variation obtained with products according to the invention is greater than 5% for a test temperature of 140° C. In addition, even after ageing at 130° C., the plastic variation relating to the H12 state is still greater than 5%. Products according to the invention also perform well in terms of corrosion. In particular, products according to the invention do not show deep pitting during a salt spray test of the SWAAT type as per standard ASTM G85A3.

It is possible that this favorable result is at least partly due to the absence of MgZn₂ precipitates which may form in the event of the simultaneous presence of Mg and Zn and which may have a detrimental effect on corrosion resistance in particular.

The preferred shape of the product extruded according to the invention is a cylindrical tube comprising only one cavity.

Products extruded according to the invention can be used in particular as tubes in motor vehicle manufacture. In particular, products extruded according to the invention can be used as lines for fuel, oil, refrigerant or brake fluid for cars, and as tubes designed for heat exchangers for engine cooling and/or air-conditioning systems for motor vehicle passenger compartments, especially if they use CO2 as a refrigerating gas. Tubes, in particular tubes drawn according to the invention, are more particularly suitable for being used in the form of cylindrical tubes, preferably comprising only one cavity for transfer piping for fluid used in air-conditioning systems for motor vehicle passenger compartments using CO2 as a refrigerating gas.

### Example

Billets were cast and homogenized in 3 alloys indexed A to C. Alloys A and B correspond to compositions of alloy AA3103 and alloy compositions according to application WO 02/055750 of prior art respectively. Alloy C complies with the invention. The compositions of the alloys (% by weight) are given in table 1.

TABLE 1
Composition of alloys A to C (% by weight).

| Ref. | Si | Fe | Cu | Mn | Mg | Cr | Zn | Ti | Zr | Ni |
|---|---|---|---|---|---|---|---|---|---|---|
| A | 0.12 | 0.56 | <0.01 | 1.11 | <0.05 | 0.02 | 0.009 | 0.01 | <0.05 | <0.01 |
| B | 0.10 | 0.27 | <0.01 | 0.97 | <0.05 | 0.19 | 0.19 | 0.01 | <0.05 | <0.01 |
| C | 0.07 | 0.14 | <0.01 | 0.99 | 0.65 | 0.20 | 0.01 | 0.01 | <0.05 | <0.01 |

The billets were extruded in coils of tubes then drawn to obtain tubes of a diameter of 12 mm and a thickness of 1.25 mm No significant difference was recorded for the three alloys as far as their potential for spinning and drawing was concerned. These coils were continuously annealed in an induction furnace at a fixed temperature of 470° C., with a throughput speed between 60 and 120 m/min The coils then underwent a new drawing pass to bring them to the H12 state according to standard EN 515. On samples of the 3 tubes, the breaking strength Rₘ (in MPa) and the yield stress R_{p0.2} (in MPa), were measured at room temperature and, for tubes B and C, at 140° C. and 170° C. in order to simulate the conditions using the tube in an air-conditioning system using CO2 as a refrigerant. The results are given in table 2.

TABLE 2
Mechanical characteristics obtained at room temperature and at high temperature

| | Temperature 20° C. | | | Temperature 140° C. | | | Temperature 170° C. | | |
|---|---|---|---|---|---|---|---|---|---|
| | Rp_{0.2} | Rm | | Rp_{0.2} | Rm | | Rp_{0.2} | Rm | |
| Ref. | (MPa) | (MPa) | R_{p %} | (MPa) | (MPa) | R_{p %} | (MPa) | (MPa) | R_{p %} |
| A | 110 | 122 | 11 | | | | | | |
| B | 122 | 132 | 8 | 112 | 112 | 0 | 106 | 106 | 0 |
| C | 177 | 187 | 6 | 160 | 172 | 8 | 154 | 169 | 10 |

It should be noted that alloy C according to the invention gives greatly improved mechanical resistance as compared to alloy B for a test carried out at room temperature, and even more greatly improved for a test carried out at 170° C. The breaking strength is improved by approximately 40% at room temperature and approximately 60% at 170° C. The plastic variation for the tests carried out at a temperature of at least 140° C. is also greatly improved, moving from 0% for alloy B to more than 5% for alloy C for temperatures of 140° C. and 170° C. The breaking strength and the yield stress properties of alloy C were also measured at 130° C. after ageing for 72 h at 130° C. and 1000 h at 130° C., and were measured at 165° C. after ageing for 72 h at 165° C. and 1000 h at 165° C. For comparison purposes, alloy B was characterized only under the severest conditions, i.e. measured at 165° C. after ageing for 1000 h at 165° C. The results are given in table 3.

TABLE 3
Mechanical characteristics obtained
after ageing at high temperature.

| | | Treatment | | | |
|---|---|---|---|---|---|
| | | 72 h at | 1000 h at | 72 h at | 1000 h at |
| | | 130° C. | 130° C. | 165° C. | 165° C. |
| | | Test temperature | | | |
| Alloy | | 130° C. | 130° C. | 165° C. | 165° C. |
| B | R_{p0.2} (MPa) | — | — | — | 99 |
| B | Rₘ (MPa) | — | — | — | 101 |
| B | R_{p %} | — | | | 2 |
| C | R_{p0.2} (MPa) | 167 | 167 | 148 | 140 |
| C | Rₘ (MPa) | 186 | 180 | 150 | 143 |
| C | R_{p %} | 11 | 8 | 1 | 2 |

It can be observed that alloy C according to the invention conserves definitely improved breaking strength and yield stress mechanical properties after ageing, since these increase by 40% in relation to alloy B.

The average grain size was measured by the intercept method on samples of the 3 tubes. The results are given in table 4. The tubes obtained with the 3 alloys have fine equiaxed grains of about 20 μm.

TABLE 4
Average grain size measured by the intercept method.

| | Direction L | Direction T | Average |
|---|---|---|---|
| Alloy | (μm) | (μm) | (μm) |
| A | 22 | 18 | 20 |
| B | 20 | 16 | 18 |
| C | 21 | 18 | 20 |

Corrosion resistance was measured using the SWAAT test (Sea Water Acetic Acid Test) as per standard ASTM G85 A3. Measurements were made for durations of 500 cycles at a temperature of 49° C., on three tubes of length 200 mm of each alloy A, B and C. At the end of the test, the tubes were removed from the enclosure and pickled in a 68% nitric acid solution in order to dissolve the corrosion products. The depth of pitting was then measured optically on the surface of each tube by defocusing, and the average depths of the 5 deepest pits were calculated. The average PAv of the values obtained for the 3 tubes was then calculated. Corrosion resistance improves as PAv decreases. The results of 5 successive SWAAT test campaigns are given in table 5. The number of * signs indicates the number of tubes bored in the batch of three tube tested.

TABLE 5
Results obtained with the SWAAT corrosion test.

| Test | Alloy A | Alloy B | Alloy C |
|---|---|---|---|
| campaign | PAv (μm) | PAv (μm) | PAv (μm) |
| 1 | 1166 ** | 216 | Not tested |
| 2 | 1250 *** | 213 | Not tested |
| 3 | 1139 | 234 | Not tested |
| 4 | Not tested | 431 | 305 |
| 5 | 1250 *** | 321 | 488 |

It can be seen that alloy C according to the invention has a corrosion behavior equivalent to that of alloy B of prior art and definitely improved in relation to that of alloy A. Alloy C has no deep pitting, given that within the context of this invention the term “deep pitting” means a PAv value greater than 0.5 mm

The composition according to the invention and in particular adding Mg and the absence of Zn makes it possible to spectacularly improve mechanical resistance, in particular for temperatures ranging between 130° C. and 170° C., without detriment to corrosion resistance, as compared to alloy B.

1. Extruded product, in particular a drawn tube, made of alloy composed as follows (% by weight):
Si<0.30, Fe:<0.30, Cu<0.05, Mn: 0.5−1.2, Mg 0.5−1.0, Zn<0.20, Cr: 0.10−0.30, Ti<0.05, Zr<0.05, Ni<0.05, others <0.05 each and <0.15 total, the rest aluminum.

2. Product according to claim 1, characterized in that Zn<0.05% by weight.

3. Product according to claim 1, characterized in that Ti<0.04% by weight and preferably Ti<0.03% by weight.

4. Product according to claim 1, characterized in that Mn: 0.9−1.1% by weight.

5. Product according to claim 1, characterized in that Cr: 0.15−0.25% by weight.

6. Product according to claim 1, characterized in that Mg: 0.6−0.9% by weight.

7. Product according to claim 1, characterized in that Fe: 0.05−0.25% by weight.

8. Product according to claim 1, characterized in that Si: 0.05−0.15% by weight.

9. Product according to claim 1, characterized in that (as a % by weight) Cu<0.01, Ni<0.01.

10. Extruded product according to claim 1, characterized in that its grain size is less than 40 μm.

11. Extruded product according to claim 1, characterized in that in H12 state its breaking strength Rm is greater than 150 MPa at room temperature, and greater than 140 MPa at 170° C.

12. Extruded product according to claim 11, composed as follows (% by weight) Si 0.05−0.15, Fe: 0.05−0.25, Cu<0.01, Mn: 0.9−1.1, Mg 0.6−0.9, Zn:<0.05, Cr: 0.15−0.25, Ti<0.04, Zr<0.04, Ni<0.01, characterized in that in H12 state its breaking strength Rm is greater than 160 MPa at room temperature and greater than 150 MPa at 170° C.

13. Extruded product according to claim 1, characterized in that this is a cylindrical tube comprising only one cavity.

14. Manufacturing process for extruded tubes according to claim 1, including casting a billet, possibly homogenizing this billet, spinning a tube, drawing this tube in one or more passes, and continuous annealing at a temperature ranging between 350 and 500° C. with a rise in temperature of less than 10s.

15. Process according to claim 14, characterized in that the rise in temperature is made in less than 2 s.

16. Process according to claim 14, characterized in that annealing is performed in an induction furnace.

17. Process according to claim 14, characterized in that annealing is followed by drawing.

18-21. (canceled)

22. A line for fuel, oil, brake fluid or refrigerant for a motor vehicle comprising an extruded product according to claim 1.

23. A line according to claim 22, in the form of a tube for a heat exchanger of an engine cooling system or air-conditioning system for a passenger compartment of a car in which CO₂ is used as refrigerating gas.

24. A line according to claim 22, in the form of a cylindrical tube comprising a single cavity, as piping for transfer of fluid in a passenger compartment air-conditioning system using CO₂ as a refrigerating gas.
